(19) United States
(12) Patent Application Publication
(10) Pub. No.: US 2009/0051525 A1
(43) Pub. Date: Feb. 26, 2009

(54) SECURITY SYSTEM AND SERVICES

(75) Inventor: James Kevin Meagher, Northamptonshire (GB)

Correspondence Address: MCDERMOTT WILL & EMERY LLP, 18191 VON KARMAN AVE., SUITE 500, IRVINE, CA, 92612-7108, US

(73) Assignee: INTAMAC SYSTEMS LIMITED, Northhampton (GB)

(21) Appl. No.: 11/632,968

(22) PCT Filed: Nov. 16, 2006
(86) PCT No.: PCT/GB2006/004287

§ 371 Date: Oct. 7, 2008

(30) Foreign Application Priority Data
Nov. 25, 2005 (GB) 0524044.5

(51) Int. Cl. G08B 1/00; G08B 25/01

(52) U.S. Cl. 340/531; 340/540

(57) ABSTRACT

A security system, comprises: a registry for registering items for which security is to be monitored, each item is identified in the registry with a unique identifier. A reporting arrangement enables a party to report an event in connection with the security of an item in the registry; and an outgoing communication arrangement is responsive to the reporting arrangement for communicating the reported event to a party associated with the item in the registry; who may then contact the system to obtain information about the reported event.

The present invention relates to security systems for property and possessions and more particularly to security support services.

Commercial and domestic properties and possessions are commonly protected by automated security alarm systems which monitor the property using electronic sensors such as motion detectors, pressure pads, door/window sensors and the like and trigger an alarm in the event that signals received from the sensors comply with a predefined pattern indicative of a security breach. However, due to the automated nature of the manner in which security breaches are detected, existing systems are prone to false alarms, which result in unnecessary police call-outs as well as nuisance in the form of noise pollution to neighbouring properties. Indeed, the high occurrence of false alarms means that many people will now simply ignore an alarm which sounds in a neighbouring property rather than investigating further or calling the police. In addition, certain municipalities have instituted a false alarm policy that imposes monetary penalties in the event a property exceeds a predetermined number of false alarms in a given time period.

Support services are available for security alarm systems which monitor the alarm status and notify the owner or another elected person in the event of the alarm being triggered. These systems still, however, primarily rely on the automated triggering of an alarm and hence do not prevent false call outs which result from faulty electronics triggering by animals or the like. Other support services use secondary confirmations of alarm situations, such as remotely interfaced security camera, accessible via the internet or the like, but these are normally very expensive and hence not practical for the average domestic property.

According to a first aspect of the present invention there is provided a security systems comprising: a registry for registering items for which security is to be monitored, wherein each item is identified in the registry with a unique identifier; a reporting arrangement for enabling a party to report an event in connection with the security of an item in the registry; an outgoing communication arrangement responsive to the reporting arrangement for communicating the reported event to a party associated with the item in the registry; and an incoming communication arrangement for enabling the party associated with the item in the registry to obtain information about the reported event.

According to another aspect of the present invention there is provided a security method, comprising the acts of registering an item with a registry using a unique identifier, using the registry to receive a report of an event in connection with the item in the registry; making an outgoing communication responsive to the reported event to a party associated with the item in the registry; and receiving an incoming communication from the party associated with the item in the registry to enable the party to obtain information about the reported event.

In order that the invention may be well understood, there will now be described an embodiment thereof, given by way of example, reference being made to the accompanying drawings, in which:

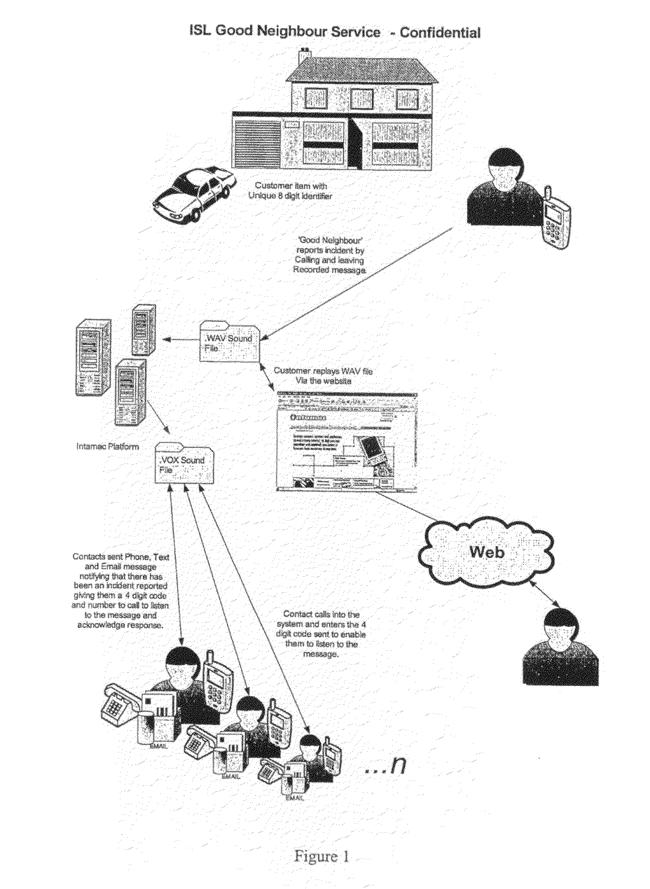

FIG. 1 is a chart summarizing the security support system of the invention;

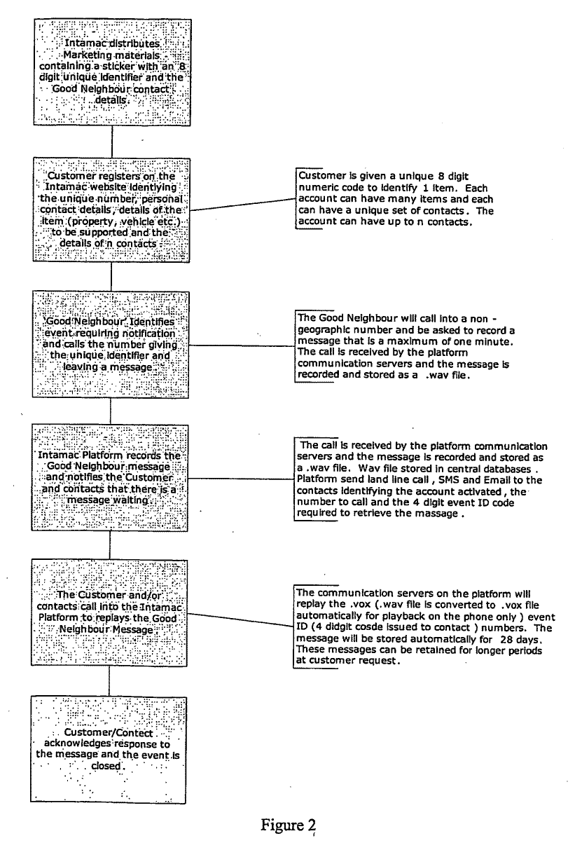

FIG. 2 is a flow chart summarizing the sign up process for the security support system; and

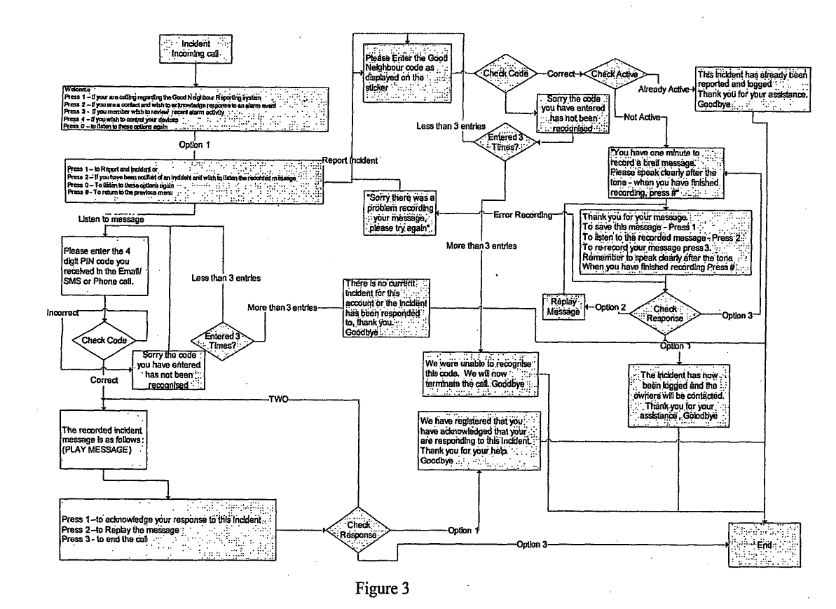

FIG. 3 is a flow chart detailing an incident reporting system for the support system of the invention.

The security support service of the invention, hereinafter referred to as the Good Neighbour system or scheme has been developed to provide people with an incident support infrastructure or their properties and possessions (Items) which is primarily driven through human reporting of possible security breaches, rather than automated systems, thereby reducing the occurrence of false alarms. The Good Neighbour scheme provides a service whereby registered Members can identify Items (Home, Vehicle, Caravan etc.) with a unique identification number.

Members who register for the service will receive an account which preferably is managed on-line using the internet but may also be controlled by telephone or other established human interface systems. This account will enable them to input their unique identification number and the details of the Item to be supported by the service. The account will also record details of the member's communication/contact details for alert notifications, which may include but are not limited to Land line telephone with recorded voice and Text-to-speech, Mobile numbers for Text SMS and an Email address, as well as possibly secondary contact points or persons.[d1]

The service will further provide a supporting identification means such as a sticker or badge that will contain both the unique identification number and a central contact telephone number, preferably non-geographic. This number can then be used to report an event by any Person who believes the Item has been compromised, damaged or stolen.

Any Person (the ‘Good Neighbour’), upon discovering a reportable event, may call the number given on the identification means and will be connected to an automated system. The servers support recorded voice and text-to-speech technology which operate to direct the caller through an initial menu. The caller will then be prompted to enter the unique identification number for the item, property or the like to which their report relates, thereby enabling correlation with the Member's account. They will then be able to leave a voice message detailing their report/concern about the item.

Once the call is completed, the system will alert the Member (and/or their Contacts) of the call by the chosen method or methods, such as SMS text, Voice message and/or Email. The system will cascade communications to the Member and then their Contacts in predefined intervals. The communications will identify that a message has been left and prompt them to call a non-geographic number to enable them to listen to the recorded message, stored in appropriate format such as .wav. Alternatively, the member may access the message through a computer interface. The message will also contain a 4 digit code (an Event Identifier) that must be entered by the Member or Contact when connecting to the system in order to obtain the incident report.

The Member and/or Contacts will then be connected to the central system from where they will be able to replay the recorded message. They will be prompted to enter the Event Identifier to gain access to the message.

The event is regarded as closed after the member or contact has dialed into the system, listened to the message, and acknowledged their response by pressing the designated key on their keypad. All those who have been communicated to are notified of the response of a member or contact. (E.g. If contact 2 agrees to respond, the member and Contact I will receive a “Response Received” message identifying that Contact 2 has responded). The recorded .wav file is then regarded as archived and can only be replayed by a Member via the web interface.

If there is no response to the event from a member or contact within a specified time period of the initial Good Neighbour call, the event is considered closed and the .wav file is archived for replay only via the member's web interface. Accordingly, if a second Good Neighbour call is received for the same item within one hour when a member or contact has not responded, the caller will be informed that there is no need to leave a message as there is currently a live activation for that Item.

Archived messages are stored in the Member's online account for a specified period of time (‘n’ days). The Member can access the online account via web interface at any time during his period, and replay this message. The Member has the ability to ‘Save’ the message and store it in the online account. If the Member does not Save the message within the specified period of time, the message file will be deleted.

The Member's online account contains historical event log data, giving detailed information on each event. This includes a time-and-date stamped record of the incident, and details of responses received into the system. The Member can, at any time, access this information via the web interface to the account.

The Good Neighbour service is supported by a resilient server platform utilising bespoke application programs for event management, file handling and communications.

The initial Good Neighbour call is recorded in .wav file format within the platform file systems. The file will be identified by matching the unique identifier input by the Good Neighbour against the registered Member's account. The receipt of a valid file is then managed by application programs that will match the file details against the Member account in the platform database. The applications will then write the Member and Contact details for this account into a temporary database file being monitored by computer telephony (CTI) application.

The CTI application will generate one telephone call to the given landline number and two emails. One email will be converted to SMS text. The same application will also await response to the event and manage replay of messages to registered members and contacts.

All events, member and contact details will be available via the platform web interface. It will, of course, be understood that although particular forms of communication have been discussed above, other communication means may be implemented both for members and also for the “Good Neighbour” to report incidents. For example, a web-based interface may be provided to enable a good neighbour to report an incident, text-to-voice software then being used to enable a member to retrieve such as report by telephone.

1. A security system, comprising: a registry for registering items for which security is to be monitored, wherein each item is identified in the registry with a unique identifier; a reporting arrangement for enabling a party to report an event in connection with the security of an item in the registry; an outgoing communication arrangement responsive to the reporting arrangement for communicating the reported event to a party associated with the item in the registry; and an incoming communication arrangement for enabling the party associated with the item in the registry to obtain information about the reported event.

2. A security system according to claim 1, wherein the reporting arrangement comprises at least one of a telephone system and a remotely accessible computer system which is accessible by the party in order to report an event.

3. A security system according to claim 1 or claim 2, wherein the reporting arrangement includes input means for the party to input a unique identification number which relates to the compromised item and details of the nature of the event.

4. A security system according to any of the preceding claims, wherein the outgoing communication system comprises at least one of SMS text messaging, Voice messaging and email.

5. A security system according to any of the preceding claims, wherein the registry stores at least one communication preference for each party associated with each item in the registry by which the outgoing communication system short report an event to them.

6. A security system according to any of the preceding claims, wherein the registry stores multiple contact options for each party associated with each item in the registry.

7. A security system according to any of the preceding claims, wherein the incoming communication system comprises at least one of a telephone system and a computer interface.

8. A security system according to claim 7, wherein the computer interface is an online system accessible via the internet.

9. A security system according to any of the preceding claims, further including archiving means for storing reports for a predefined period.

10. A security method, comprising the acts of: registering an item with a registry using a unique identifier, using the registry to receive a report of an event in connection with the item in the registry; making an outgoing communication responsive to the reported event to a party associated with the item in the registry; and receiving an incoming communication from the party associated with the item in the registry, to enable the party to obtain information about the reported event.

11. A security method according to claim 10, comprising the further step of registering with the registry a preferred means for receiving the outgoing communication.

12. A security method according to claim 10 or claim 11, comprising the further step of collecting unique identifier information with each report in order to identify the item in the registry to which the report relates.

13. A security method according to claim 12, comprising the step of storing the report for access by the party associated with the item in the registry to which the report relates.

14. A security method according to claim 13, wherein each report is stored in the registry for a predefined period.
